(19) United States
(12) Patent Application Publication
(10) Pub. No.: US 2020/0043369 A1
(43) Pub. Date: Feb. 6, 2020

(54) Set of Geometrical Objects and Method to Explain Algebraic Equations

(71) Applicant: Bhavya Shah, Gujarat (IN)

(72) Inventor: Bhavya Shah, Gujarat (IN)

(21) Appl. No.: 16/520,344

(22) Filed: Jul. 23, 2019

(30) Foreign Application Priority Data
Aug. 2, 2018 (IN) 201821029044

(51) Int. Cl. G09B 23/04; G09B 19/02

(52) U.S. Cl. CPC G09B 23/04; G09B 19/02

(57) ABSTRACT

A set of geometrical objects comprising square prism (420); square prism (460); rectangle prism (465); three square prisms (530); cube (440), cube (550), cube and (590); rectangle prism (490); two rectangle prisms (470); rectangle prism (475); two rectangle prisms (500); two rectangle prisms (510); and four rectangle prisms (600) and a method for explaining algebraic equations (a+b)²=a²+2ab+b²; (a−b)²=a²−2ab+b²; (a+b+c)²=a²+b²+c²+2ab+2bc+2ca; (a+b)³=a³+b³+3a²b+3ab²; (a+b)×(a−b)=a²−b²; and (x+y)²−(x−y)²=4xy.

### RELATED APPLICATION

This application claims priority to Indian Application No. 201821029044 filed Aug. 2, 2018 entitled, “Set of Geometrical Objects and Method to Explain Algebraic Equations”, which is incorporated herein by reference in its entirety.

### FIELD OF THE INVENTION

The field of the invention relates to objects used to teach mathematics. The field of invention further relates to objects and methods for explaining algebraic equations

### Use of the Invention

Many, if not most children, find mathematics challenging. In order not to fail an examination of mathematics as a subject, students often resort to rote learning techniques without understanding or gaining knowledge that could be applied or put to use.

The present invention simplifies explanation of basic formulae and algebraic equations so that children gain fundamental understanding of the formulae and algebraic equations.

After gaining understanding of formulae and algebraic equations using the present invention, the children may not need to memorize formulae and algebraic equations taught in accordance with the present invention.

### Prior Art and Problem to be Solved

Numerous text books on mathematics have been published for a long time. Several games have been marketed to teach basic mathematics. Tools, including computer applications have been developed to teach mathematics. Still however, mathematics remains one subject that scares many, if not most students and the chief reason for that is weak understanding of the fundamentals.

US Publication No. US 2015/0132727 A1 discloses a set of education blocks and method for teaching mathematics through equation checking. It discloses polygonal-shaped numeral blocks each having a number of faces with the top face including a numeral and the bottom face including a dot pattern corresponding to the numeral on the top face. Selected numeral and operator blocks are selectively arranged to form an equation. The bottoms of the blocks reveal correctness or incorrectness of the equation. Colours indicate odd, even or prime numbers. The invention, however, does not help students gain an understanding of algebraic equations.

US Publication No. US 2011/0300521 A1 discloses a didactic Pythagorean set that permits working of the Pythagorean Theorem. The invention sets out in arithmetic, geometric and algebraic way the Pythagorean result. It also enables students of high school and college to be introduced to trigonometric functions. The invention, however, requires somewhat costly tools and is focused on working the Pythagorean Theorem.

U.S. Pat. No. 5,873,729 discloses a mathematical triangle kit designed to teach children and adults mathematical and symmetry skills utilizing various sized patterned blocks. Skills like fractions, multiplication, trigonometry, and geometry can be learned by manipulating the patterned blocks. The said invention also discloses sets of various sized and coloured triangles with 30° and 60° bases. The invention, however, does not help students gain an understanding of algebraic equations.

The Prior Art falls short of explaining algebraic equations in a way that students gain a deep understanding making memorizing avoidable.

### OBJECTS OF THE INVENTION

An object of the present invention is to provide to children an opportunity to gain fundamental understanding of algebraic equations.

A further object of the present invention is to provide to children tools that can be used to express algebraic equations for better understanding.

Yet another object of the present invention is to provide a method of expressing algebraic equations by the geometrical objects made in accordance with the present invention.

### SUMMARY OF THE INVENTION

The present invention discloses a set of geometrical objects comprising square prism (420); square prism (460); three square prisms (530); cube (440), cube (550), cube and (590); rectangle prism (490); two rectangle prisms (470); two rectangle prisms (500); two rectangle prisms (510); and four rectangle prisms (600) and a method for explaining algebraic equations (a+b)²=a²+2ab+b²; (a−b)²=a²−2ab−b²; (a+b+c)²=a²+b²+c²+2ab+2bc+2ca; (a+b)³=a³+b³+3a²b+3ab²; (a+b)×(a−b)=a²−b²; and (x+y)²−(x−y)²=4xy.

The side of square prism (420) is substantially as long as the length of rectangle prism (430) and the breadth and width of rectangle prisms (430) is substantially as long as the side of cube (440) and width of square prism (420). The side of square prism (460) is substantially as long as the length of rectangle prisms (470) and the breadth and width of rectangle prisms (470) is substantially as long as the side of cube (440) and the width of square prism (460). The breadth and width of rectangle prism (490) is substantially as long as the breadth of rectangle prisms (500) and (510). The length of rectangle prism (490) is substantially as long as the width of rectangle prisms (500) and (510) and the side of cube (440) and the width of square prism (420). The length of rectangle prism (500) is substantially as long as the side of cube (440), and the length of rectangle prism (510) substantially as long as the side of square prism (420). The length of rectangle prism (510) is substantially as long as the side of square prism (420). The three square prisms (530) have sides substantially as long as the length of the side of cube (550) and width substantially as long as the side of cube (440) and three rectangle prisms (540) have length substantially as long as the side of cube (550) and breadth and width substantially as long as the side of cube (440). Cube (590) and the four rectangle prisms (600) have length longer than the side of cube (590) and breadth shorter than the side of cube (590) and width substantially as long as the side of the cube (590).

By forming square prism (410) using square prism (420), two rectangle prisms (430), and cube (440) and adding area of the top face of the square prism (420), areas of top faces of the two rectangle prisms (430) and area of top face of the cube (440), algebraic equation, (a+b)²=a²+2ab+b² can be explained. By forming square prism (450) using square prism (460), two rectangle prisms (470), and cube (440) and subtracting from the area of top face of the square prism (450) area of top faces of the rectangle prisms (470) and area of top face of cube (440), algebraic equation, (a−b)²=a²−2ab−b² can be explained. By forming square prism (480) using square prism (420), two rectangle prisms (430), cube (440); two rectangle prisms (510), two rectangle prisms (500) and rectangle prism (490) and adding area of the top face of the square prism (420), areas of top faces of the two rectangle prisms (430), area of top face of the cube (440), areas of top faces of the two rectangle prisms (510), areas of top faces of the two rectangle prisms (500), and area of top face of rectangle prism (490), algebraic equation, (a+b+c)²=a²+b²+c²+2ab+2bc+2ca can be explained. By forming cube (520) using cube (550), three square prisms (530), three rectangle prisms (540, and cube (440) and adding volumes of cube (550), three square prisms (530), three rectangle prisms (540, and cube (440), algebraic equation, (a+b)³=a³+b³+3a²b+3ab² can be explained. By forming rectangle prism (560) using square prism (460), two rectangle prisms (470), and cube (440) and adding area of top face of square prism (465) and area of top face of rectangle prism (475), algebraic equation, (a+b)×(a−b)=a²−b² can be explained. By forming square prism (580) using four rectangle prisms (600) and cube (590), algebraic equation, (x+y)²−(x−y)²=4xy can be explained.

### BRIEF DESCRIPTION OF THE DRAWINGS

FIG. 1A shows top view of a geometrical object having the shape of an isosceles triangle.

FIG. 1B shows top view of a geometrical object having the shape of a rectangle formed by combining a geometrical object having the shape of an isosceles triangle and two geometrical objects, each having the shape of a right-angled triangle.

FIG. 1C shows top view of a geometrical object having the shape of a pentagon formed by combining two geometrical objects, each having the shape of a right-angled triangle and a geometrical object having the shape of a triangle.

FIG. 1D shows top view of a geometrical object having the shape of a hexagon formed by combining two geometrical objects, each having the shape of a right-angled triangle and two geometrical objects having the shape of a triangle.

FIG. 1E shows top view of a geometrical object having the shape of an octagon formed by combining two geometrical objects, each having the shape of a right-angled triangle; two geometrical shapes, each having the shape of a big triangle; and two geometrical objects, each having the shape of a small triangle.

FIG. 2A shows top view of a geometrical object having the shape of a parallelogram formed by combining a geometrical object having the shape of a right-angled triangle and a geometrical object having the shape of a trapezoid.

FIG. 2B shows top view of a geometrical object having the shape of a square formed by combining a geometrical object having the shape of a trapezoid and a geometrical object having the shape of a right-angled triangle.

FIG. 3A shows top view of a geometrical object having the shape of a rectangle formed by combining three geometrical objects of different sizes each having the shape of a triangle wherein two are having the shape of a right-angled triangle and one is having the shape of an acute triangle.

FIG. 3B shows top view of a geometrical object having the shape of a parallelogram formed by combining three geometrical objects, each having the shape of a triangle, but of different sizes.

FIG. 4A shows top view of a geometrical object having the shape of a rectangle formed by combining three geometrical objects, each having the shape of a triangle.

FIG. 4B shows top view of a geometrical object having the shape of a parallelogram formed by combining three geometrical objects, each having the shape of a triangle, but of different sizes.

FIG. 5A shows top view of a geometrical object having the shape of a rhombus formed by combining four geometrical objects, each having the shape of a right-angled triangle.

FIG. 5B shows top view of a geometrical object having the shape of a right-angled triangle.

FIG. 6 shows top view of a geometrical object having the shape of a trapezoid formed by combining two geometrical objects, each having the shape of a triangle and a geometrical object having the shape of a rectangle.

FIG. 7 shows top view of a geometrical object having the shape of a triangle formed by combining three geometrical objects, each having the shape of a triangle and a geometrical object having the shape of a six-sided polygon.

FIG. 8 shows top view of a geometrical object having the shape of a trapezoid formed by combining three geometrical objects, each having the shape of a triangle.

FIG. 9 shows top view of a geometrical object having the shape of a square prism formed by combining two cubes and two rectangle prisms.

FIG. 10 shows top view of a geometrical object having the shape of a square prism formed by combining two cubes and two rectangle prisms.

FIG. 11 shows top view of a geometrical object having the shape of a square prism formed by combining a square prism and eight rectangle prisms.

FIG. 12 shows a three-dimensional view of a geometrical object having the shape of a cube formed by combining two cubes, three square prisms, and three rectangle prisms.

FIG. 13A shows top view of a geometrical object having the shape of a rectangle prism formed by combining a square prism, a cube and two rectangle prisms.

FIG. 13B shows top view of a geometrical object having the shape of a rectangle prism formed by combining a square prism and a rectangle prism.

FIG. 14 shows top view of a geometrical object having the shape of a square prism formed by combining four rectangle prisms and a cube.

### DETAILED DESCRIPTION OF THE INVENTION

The present invention discloses a set of geometrical objects such as square prism (420); square prism (460); three square prisms (530); cube (440), cube (550), cube and (590); rectangle prism (490); two rectangle prisms (470); two rectangle prisms (500); two rectangle prisms (510); and four rectangle prisms (600) some of which can be combined with each other in the manner disclosed for explaining algebraic equations (a+b)²=a²+2ab+b²; (a−b)²=a²−2ab−b²; (a+b+c)²=a²+b²+c²+2ab+2bc+2ca; (a+b)³=a³+b³+3a²b+3ab²; (a+b)×(a−b)=a²−b²; and (x+y)²−(x−y)²=4xy.

As a person skilled in the art will readily understand, by combining, it is meant that the geometrical objects are placed adjacent to other geometrical objects to form different geometrical objects. The geometrical objects need not attach to each other. In other words, they are placed side-by-side in a manner disclosed herein.

The sizes of the geometrical objects square prism (420); square prism (460); three square prisms (530); cube (440), cube (550), cube and (590); rectangle prism (490); two rectangle prisms (470); two rectangle prisms (500); two rectangle prisms (510); and four rectangle prisms (600) in accordance with the present invention for explaining algebraic equations (a+b)²=a²+2ab+b²; (a−b)²=a²−2ab−b²; (a+b+c)²=a²+b²+c²+2ab+2bc+2ca; (a+b)³=a³+b³+3a²b+3ab²; (a+b)×(a−b)=a²−b²; and (x+y)²−(x−y)²=4xy are chosen as described hereinafter:

The side of square prism (420) is substantially as long as the length of rectangle prism (430) and the breadth and width of rectangle prisms (430) is substantially as long as the side of cube (440) and width of square prism (420). The side of square prism (460) is substantially as long as the length of rectangle prisms (470) and the breadth and width of rectangle prisms (470) is substantially as long as the side of cube (440) and the width of square prism (460). The breadth and width of rectangle prism (490) is substantially as long as the breadth of rectangle prisms (500) and (510). The length of rectangle prism (490) is substantially as long as the width of rectangle prisms (500) and (510) and the side of cube (440) and the width of square prism (420). The length of rectangle prism (500) is substantially as long as the side of cube (440), and the length of rectangle prism (510) substantially as long as the side of square prism (420). The length of rectangle prism (510) is substantially as long as the side of square prism (420). The three square prisms (530) have sides substantially as long as the length of the side of cube (550) and width substantially as long as the side of cube (440) and three rectangle prisms (540) have length substantially as long as the side of cube (550) and breadth and width substantially as long as the side of cube (440). Cube (590) and the four rectangle prisms (600) have length longer than the side of cube (590) and breadth shorter than the side of cube (590) and width substantially as long as the side of the cube (590).

In order to efficiently identify corresponding geometrical objects, they may be colour coded. Also, the geometrical objects may have English alphabets “a”, “b”, or “c” or “x”, “y”, “z” written on appropriate sides on the top and bottom so that both, the top and bottom surfaces can function as the face of the geometrical object. Generally, “a” or “x” will indicate the length of a geometrical object, “b” or “y” will indicate the breadth, and “c” or “z” will indicate the width. A person skilled in the art will readily understand this. When necessary, some geometrical objects may indicate angles using conventional Greek alphabets, such as α, β, and γ.

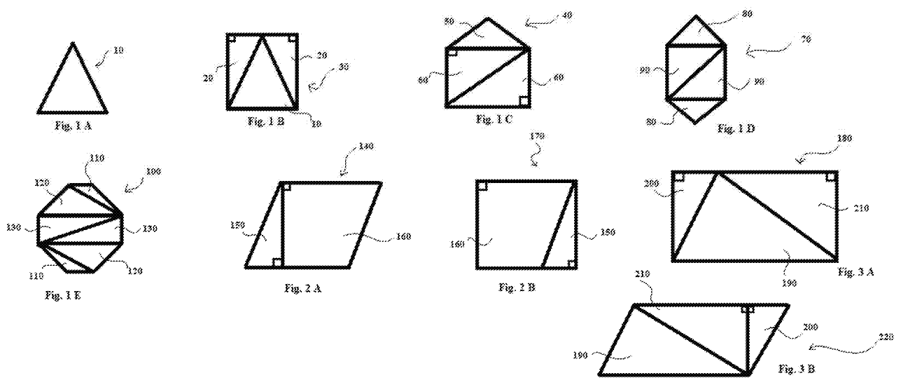

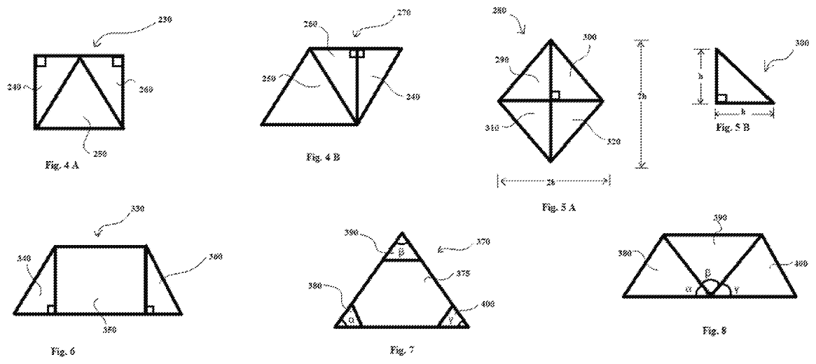

A person skilled in the art would know that a triangle is the most basic shape. This can be illustrated using FIG. 1A to FIG. 6.

Now referring to FIG. 1A, it shows isosceles triangle (10). It has three equal sides and equal angles and some thickness.

FIG. 1B shows rectangle (30) formed by combining isosceles triangle (10) and two identical right-angled triangles (20). It is common knowledge that the end result will be rectangle (30) when two such right-angled triangles (20) are combined with an isosceles triangle (10) as shown in FIG. 1B; however, when a child actually combines such objects to form rectangle (30) as shown, the concept will be clearly grasped by the child. A person skilled in the art will readily understand that the height of the two identical right-angled triangles (20) will be the same as the height of isosceles triangle (10) and the side of rectangle (30) so formed also will be the same. Any other type of triangles can also be used in place of right-angled triangles (20) as a person skilled in the art will readily understand. The child forming rectangle (30) will also understand that the sum of the areas of the two right-angled triangles (20) and that of the isosceles triangle (10) will be the same as the area of rectangle (30).

FIG. 1C shows pentagon (40) formed by combining two identical right-angled triangles (60) and a triangle (50). FIG. 1D shows hexagon (70) formed by combining two right-angled triangles (90) and two triangles (80). FIG. 1E shows an octagon (100) formed by combining two right-angled triangles (130); two big triangles (120); and two small triangles (110).

Thus, FIG. 1B to FIG. 1E show that by combining triangles, a single geometrical object can be formed. The area of the combined geometrical object will be the sum of the areas of the top surfaces of the individual triangles used in the combination.

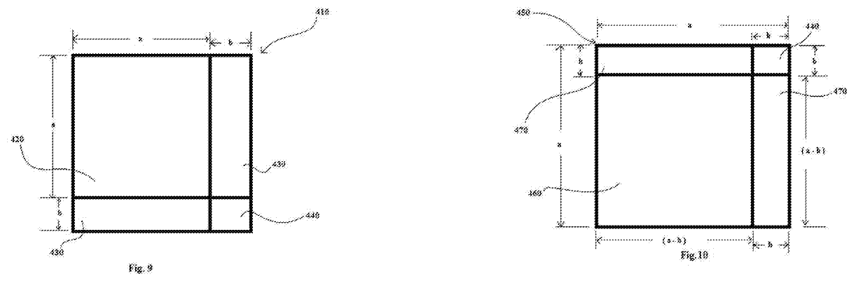

Now referring to FIG. 2A, it shows parallelogram (140) formed by combining right-angled triangle (150) and trapezoid (160). A person skilled in the art will readily understand that by combining two triangles, trapezoid (160) can be formed. Placing right-angled triangle (150), as shown in FIG. 2B, square (170) is formed.

FIG. 3A shows rectangle (180) formed by combining right-angled triangle (200), acute triangle (190), and right-angled triangle (210). Placing right-angled triangle (200) as shown in FIG. 3B, parallelogram (220) can be formed.

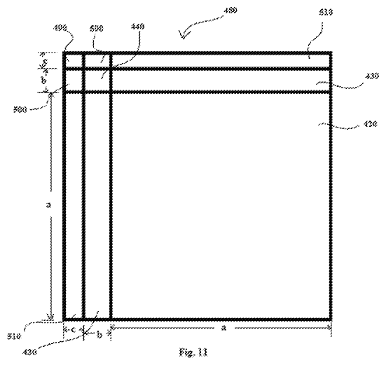

FIG. 4A shows rectangle (230) formed by combining right-angled triangle (240), triangle (250), and right-angled triangle (260). Children are taught to memorize that area of a triangle is half the product of the base of the triangle and the height of it. In other words, a triangle's area=½×base×height. Using the geometrical objects in accordance with the present invention, it can be easily demonstrated that a triangle's area=½×base×height. A child would have to form rectangle (230) by combining triangle (240), triangle (250), and triangle (260). The child would easily know that the area of rectangle (230) is the product of the long side and the short side of the rectangle. The long side of rectangle (230) is same as the base of triangle (250) and the height of rectangle (230) is same as the height of 30 triangle (250). Now, placing right-angled triangle (240) as shown in FIG. 4B, parallelogram (270) is formed. It can be seen that the area of triangle (250) and that of the triangle formed by combining right-angled triangles (260) and (240) is the same. Therefore, it can be demonstrated to the child that the area of either of the triangles, i.e. triangle (250) or that of the triangle formed by combining right-angled triangles (260) and (240) is half that of the area of rectangle (230). Therefore, the child readily understands that a triangle's area=½×base×height.

FIG. 5A shows rhombus (280) formed by combining four identical right-angled triangles (290), (300), (310), and (320). The base of each of the right-angled triangles can be represented by “b” and the height by “h” as is conventionally done. It can be easily seen from FIG. 5B that shows right-angled triangle (300) separately that its area is equal to ½×b×h. Rhombus (280) will have a long diagonal and a short diagonal. The long diagonal will be twice the length of the height of right-angled triangle (300) and the short diagonal will be twice the length of the base of right-angled triangle (300). Thus, the long diagonal will be 2×h and the short diagonal will be 2×b. Therefore, the area of rhombus (280) will be four times the areas of right-angled triangles (290), (300), (310), and (320) or 4×½×b×h. Expressing in terms of the base and height of right-angled triangle (300), area of rhombus (280) will be 2×b×h. Expressing differently, area of rhombus (280) will be ½×long diagonal×short diagonal.

FIG. 6 shows trapezoid (330) formed by combining two right-angled triangles (340) and (360) and rectangle (350). Thus, a child will readily know that the area of trapezoid (330) can easily be determined by combining the areas of right-angled triangles (340) and (360) and rectangle (350).

FIG. 7 shows triangle (370) formed by combining three triangles (380), (390), and (400) geometrical objects and six-sided polygon (375). Triangle (370) has angles α, β, and γ as shown in FIG. 7. Triangles (380), (390), and (400) also have the same angles as shown in FIG. 7. Rearranging triangles (380), (390), and (400) as shown in FIG. 8 into a trapezoid, it makes it evident to a child that the sum of the angles α, β, and γ is 180°. This also shows that the sum of angles of triangle (370) is also 180°.

FIG. 9 shows square prism (420), two rectangle prisms (430), and cube (440) such that the side of square prism (420) is substantially as long as the length of rectangle prism (430) and the breadth and width of rectangle prisms (430) is substantially as long as the side of cube (440) and width of square prism (420). Square prism (410) can be formed by combining square prism (420), cube (440) and two rectangle prisms (430). Each side of the top face of square prism (420) is represented by “a” and that of cube (440) by “b”. Algebraic equation (a+b)²=a²+2ab+b² can be explained using the present invention. Ordinarily, students simply remember the equation. Now, combining square prism (420) and cube (440) and two rectangle prisms (450) as shown in FIG. 9, the said equation need not be remembered, but will be understood. Total length of each side of top face of square prism (410) is a+b. Now, area of top face of square prism (420) will be a² and this, a student need not remember, as it is very basic. Similarly, area of top face of cube (440) will be b². Each of both rectangle prisms (430) will have top face area a×b or ab. Combining areas of top faces of square prism (420) and top face of cube (440) and top face of both rectangle prisms (430), it can easily be seen that area of square prism (410) is (a+b)×(a+b) that is equal to a²+ba+ab+b². Expressed differently, it becomes evident that (a+b)²=a²+2ab+b². Therefore, instead of remembering the equation, a child can easily learn how the equation is derived and need not remember it. Thus, forming square prism (410) using square prism (420), two rectangle prisms (430), and cube (440) and adding area of the top face of the square prism (420), areas of top faces of the two rectangle prisms (430) and area of top face of the cube (440), algebraic equation, (a+b)²=a²+2ab+b² can be explained.

FIG. 10 explains the concept for algebraic equation, (a−b)²=a²−2ab+b². FIG. 10 shows square prism (460) and two rectangle prisms (470) such that the side of top face of square prism (460) is substantially as long as the length of rectangle prisms (470). The breadth and width of rectangle prisms (470) is substantially as long as the side of cube (440) and also the width of square prism (460). Each side of the top face of the formed square prism (450) is represented by “a”. It can be understood that the area of the top face of square prism (450) is a². The area of top face of cube (440) is b². The area of top face of each of the two rectangle prisms (470) is (a−b)×b or ab−b². The area of the top face of square prism (460) will be (a−b)². In order to determine (a−b)² or area of square (470), all one has to do is figure out the area of the top face of square prism (450) and subtract the area of the top faces of both rectangle prisms (470) and the area of the top face of cube (440). Thus, a²−(ab−b²)−(ab−b²)−b²=a²−2ab+b², where, area of the top face of square prism (450) is a², the sum of the areas of the top faces of rectangle prisms (470) is 2ab and area of the top face of square prism (440) is b². The child using the present invention need not memorize the said equation. Thus, forming square prism (450) using square prism (460), two rectangle prisms (470), and cube (440) and subtracting from the area of top face of square prism (450) area of top faces of rectangle prisms (470) and area of top face of cube (440), algebraic equation, (a−b)²=a²−2ab+b² can be explained.

FIG. 11 shows square prism (420) and two rectangle prisms (430) such that the side of top face of square prism (420) is substantially as long as the length of rectangle prisms (430). The breadth and width of rectangle prisms (430) is substantially as long as the side of cube (440) and also the width of square prism (420). Rectangle prism (490), two rectangle prisms (500), and two rectangle prisms (510) are also shown such that the breadth and width of rectangle prism (490) is substantially as long as the breadth of rectangle prisms (500) and (510). The length of rectangle prism (490) is substantially as long as the width of rectangle prisms (500) and (510) and the side of cube (440) and the width of square prism (420). The length of rectangle prism (500) is substantially as long as the side of cube (440) and the length of rectangle prism (510) is substantially as long as the side of square prism (420). As shown in FIG. 11, the length of the side of square prism (420) is represented by “a”. Therefore, area of the top face of square prism (420) is a². The length of the side of cube (440) is represented by “b”. Therefore, area of the top surface of cube (440) is b². The length and breadth of each of the two rectangle prisms (430) is represented by “a” and “b” respectively. Therefore, the area of the top face of each of the two rectangle prisms (430) is a×b or ab or ba. The length and breadth of each of the two rectangle prisms (510) is represented by “a” and “c” respectively. Therefore, the area of the top face of each of the two rectangle prisms (510) is a×c or ac or ca. The length and breadth of each of the two rectangle prisms (500) is “b” and “c” respectively. Therefore, the area of the top face of each of the two rectangle prisms (500) is b×c or be or cb. The breadth and width of rectangle prism (490) is represented by “c”. Therefore, the area of the top face of rectangle prism (490) is c². Square prism (480) is formed by combining square prism (420), two rectangle prisms (430), cube (440), two rectangle prisms (510), two rectangle prisms (500) and rectangle prism (490) as shown in FIG. 11. It can be understood that length of each side of the top face of square prism (480) can be represented by a+b+c. Therefore, the area of the top face of square prism (480) will be (a+b+c)². Ordinarily, a student will remember the expansion of such an equation; however, using the present invention, it need not be remembered. Total area of the top faces of square prism (420), cube (440) and rectangle prism (490) will be a²+b²+c² respectively. The total area of the top faces of the two rectangle prisms (430) will be 2ab. Likewise, total area of the top faces of the two rectangle prisms (500) will be 2bc and the total area of the top faces of the two rectangle prisms (510) will be 2ca. Combining all the areas, we will have a²+b²+c²+2ab+2bc+2ca. Thus, the equation (a+b+c)²=a2+b²+c²+2ab+2bc+2ca can easily be derived using the present invention and need not be remembered. Thus, forming square prism (480) using square prism (420), two rectangle prisms (430), cube (440); two rectangle prisms (510), two rectangle prisms (500) and rectangle prism (490) and adding area of the top face of the square prism (420), areas of the top faces of the two rectangle prisms (430), area of the top face of the cube (440), areas of the top faces of the two rectangle prisms (510), areas of the top faces of the two rectangle prisms (500), and area of the top face of rectangle prism (490), algebraic equation, (a+b+c)²=a²+b²+c²+2ab+2bc+2ca can be explained.

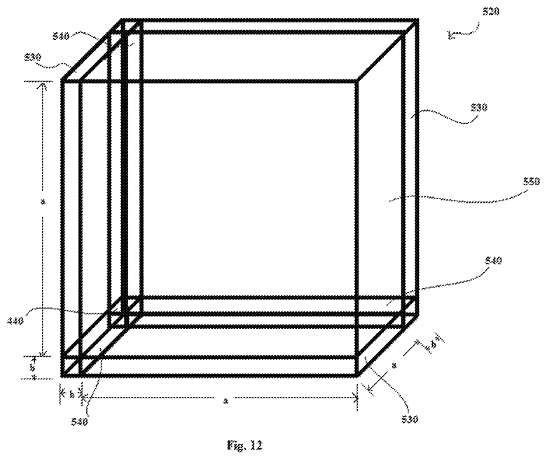

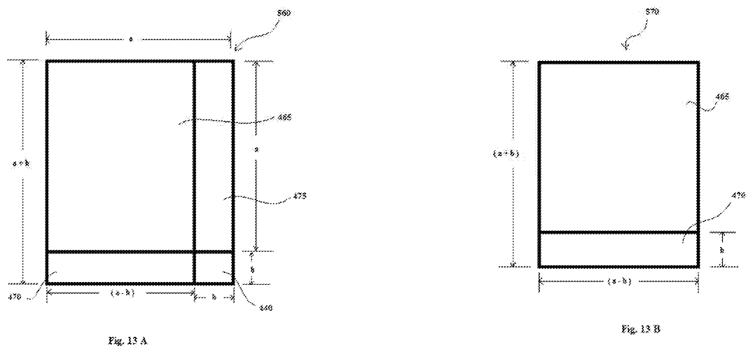

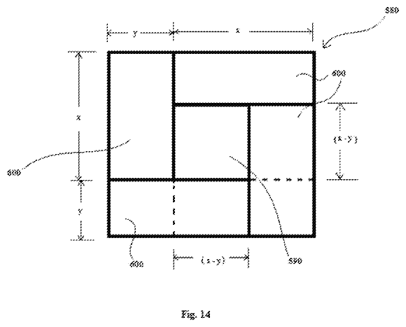

FIG. 12 shows three square prisms (530) having sides substantially as long as the length of the side of cube (550) and width substantially as long as the side of cube (440) and three rectangle prisms (540) having length substantially as long as the side of cube (550) and breadth and width substantially as long as the side of cube (440). Each side of cube (550) can be represented by “a”. Therefore, the volume of cube (550) will be a³. Each side of cube (440) can be represented by “b”. Therefore, the volume of cube (440) will be b³. The side of square prism (530) is represented by “a” and width by “b”. Therefore, the volume of each square prism (530) will be a^{l}b and since there are three square prisms (530), the total volume of the three square prisms (530) will be 3a²b. The length of rectangle prism (540) is represented by “a” and breadth and width by “b”. Therefore, the volume of rectangle prism (540) is ab² and since there are three rectangle prisms (540), the total volume of the three rectangle prisms (540) will be 3ab². Cube (520) can be formed by using cube (550), three square prisms (530), three rectangle prisms (540), and cube (440). It can be seen that the volume of cube (550) will be (a+b)³. Combining the volumes of cube (550), three square prisms (530), three rectangle prisms (540), and cube (440) will yield a³+b³+3a²b+3ab². Thus, (a+b)³=a³+b³+3a²b+3ab² need not be memorized.

FIG. 13A shows rectangle prism (560) formed by rectangle prism (465), rectangle prism (470), rectangle prism (475), and cube (440). Length of rectangle prism (465) is represented by “a”. Breadth of rectangle prism (470) is represented by “b”. Thus, the length of the rectangle prism (560) is (a+b). Breadth of rectangle prism (475) is represented by “b” and its length is represented by “a”. The length of side of cube (440) is represented by “b”. Thus, the breadth of rectangle prism (465) is (a−b). The area of top face rectangle prism (560) will be a×(a+b). The area of the top face of rectangle prism (475) will ab and the area of the top face of cube (440) will be b². Now, if rectangle prism (475) and cube (440) are removed as shown in FIG. 13B, rectangle prism (465) and rectangle prism (470) will be left forming rectangle prism (570). Area of the top face of rectangle prism (570) will be (a+b)×(a−b). Now, subtracting from area a×(a+b) of the top face of rectangle prism (560) area ab of the top face of rectangle prism (475) and area b² of the top face of cube (440) will yield a²−b². Thus, (a+b)×(a−b)=a²−b² can be explained.

FIG. 14 shows square prism (580) formed by combining four rectangle prisms (600) and rectangle prism (590). As can be seen in FIG. 14, the length of each side of square prism (580) is (x+y). Each rectangle prism (600) has length “x” and breadth “y”. Cube (590) has side length (x−y). Now, algebraic equation (x+y)²−(x−y)²=4xy is memorized by students, but the present invention helps students understand how the said equation is derived so that they don't have to memorize it. Area of the top face of square prism (580) will be (x+y)² and area of the top face of cube (590) will be (x−y)². Therefore, subtracting area of the top face of cube (590) from the area of the top face of square prism (580) leaves the total area of the top faces of the four rectangle prisms (600) 4xy. Thus, (x+y)²−(x−y)²=4xy need not be memorized.

### BEST METHOD OF PERFORMING THE INVENTION

The present invention is described hereinabove in detail; however, the best method of performing the invention will be to have colour coded objects. The English alphabets “a”, “b”, “c”, “x”, “y”, “z” and areas of top faces may be printed on the objects for easy identification.

The best method to perform the present invention is to use geometrical objects made out of wood or plastic. As a person skilled in the art will readily understand that instead of wood or plastic, even cardboard can be used to explain most equations.

The detailed description hereinabove illustrates the principle of the inventive idea of the present invention. Various modifications without departing from the spirit and scope of the present invention will be apparent to a person skilled in the art. The disclosure hereinabove ought not to be construed to limit the scope of the present invention. The present invention should not be considered to be limited to what has been discussed hereinabove.

What is claimed is:

1. A set of geometrical objects for explaining algebraic equations (a+b)²=a²+2ab+b²; (a−b)²=a²−2ab−b²; (a+b+c)²=a²+b²+c²+2ab+2bc+2ca; (a+b)³=a³+b³+3a²b+3ab²; (a+b)×(a−b)=a²−b²; and (x+y)²−(x−y)²=4xy, the set of geometrical objects comprising
a. a first square prism (420), two first rectangle prisms (430), and a first cube (440) having dimensions such that a side of the first square prism (420) is substantially as long as a length of the first rectangle prisms (430) and a breadth and width of the first rectangle prisms (430) is substantially as long as a side of the first cube (440) and a width of the first square prism (420);
b. a second square prism (460) and two second rectangle prisms (470) such that a side of second square prism (460) is substantially as long as a length of the second rectangle prisms (470) and a breadth and width of the second rectangle prisms (470) is substantially as long as the side of the first cube (440) and the width of the second square prism (460);
c. a third rectangle prism (490), two fourth rectangle prisms (500), and two fifth rectangle prisms (510) such that
i. a breadth and width of the third rectangle prism (490) is substantially as long as a breadth of the fourth and fifth rectangle prisms (500) and (510),
ii. a length of the third rectangle prism (490) is substantially as long as a width of the fourth and fifth rectangle prisms (500) and (510) and the side of the cube (440) and the width of the first square prism (420),
iii. the length of the fourth rectangle prisms (500) is substantially as long as the side of the first cube (440), and a length of the fifth rectangle prisms (510) is substantially as long as the side of first square prism (420);
iv. the length of fifth rectangle prism (510) is substantially as long as the side of first square prism (420);
d. three third square prisms (530) having sides substantially as long as the length of a side of a second cube (550) and a width substantially as long as the side of the first cube (440) and three sixth rectangle prisms (540) having length substantially as long as a side of the second cube (550) and a breadth and width substantially as long as the side of first cube (440);
e. a sixth rectangle prism (465) and a seventh rectangle prism (475) such that the length of the sixth rectangle prism (465) is substantially the same as a length of the seventh rectangle prism (475) and a breadth of the sixth rectangle prism (465) is substantially the same as a length of the second rectangle prisms (470) and a breadth of seventh rectangle prism (475) is substantially as long as the side of the first cube (440); and
f. a third cube (590) and four eighth rectangle prisms (600) having a length longer than a side of the third cube (590) and a breadth shorter than a side of the third cube (590) and a width substantially as long as the side of the third cube (590).

2. A method of explaining algebraic equations using a set of geometrical objects, the method comprising the steps of
a. forming a first square prism (410) using a second square prism (420), two first rectangle prisms (430), and a first cube (440) and adding an area of a top face of the second square prism (420), areas of top faces of the two first rectangle prisms (430) and an area of a top face of the first cube (440) to explain algebraic equation, (a+b)²=a²+2ab+b²;
b. forming a third square prism (450) using a fourth square prism (460), two second rectangle prisms (470), and the first cube (440) and subtracting from an area of a top face of the third square prism (450) an area of top faces of the second rectangle prisms (470) and an area of a top face of the first cube (440) to explain algebraic equation, (a−b)²=a²−2ab+b²;
c. forming a fifth square prism (480) using the second square prism (420), two first rectangle prisms (430), the first cube (440); two third rectangle prisms (510), two fourth rectangle prisms (500) and a fifth rectangle prism (490) and adding an area of the top face of the second square prism (420), areas of top faces of the two first rectangle prisms (430), an area of the top face of the first cube (440), areas of top faces of the two third rectangle prisms (510), areas of top faces of the two fourth rectangle prisms (500), and an area of a top face of the fifth rectangle prism (490) to explain algebraic equation, (a+b+c)²=a²+b²+c²+2ab+2bc+2ca;
d. forming second cube (520) using a third cube (550), three sixth square prisms (530), three sixth rectangle prisms (540), and the first cube (440) and adding volumes of the third cube (550), the three sixth square prisms (530), the three sixth rectangle prisms (540), and the first cube (440) to explain algebraic equation, (a+b)³=a³+b³+3a²b+3ab²;
e. forming a seventh rectangle prism (570) using a seventh square prism (465) and the second rectangle prism (470) and adding an area of a top face of the seventh square prism (465) and an area of a top face of the second rectangle prism (470) to explain algebraic equation, (a+b)×(a−b)=a²−b²; and
f. forming an eighth square prism (580) using four eighth rectangle prisms (600) and a fourth cube (590) to explain algebraic equation, (x+y)²−(x−y)²=4xy.
